(19) United States
(12) Patent Application Publication
(10) Pub. No.: US 2007/0065773 A1
(43) Pub. Date: Mar. 22, 2007

(54) Root canal obstruction removal system

(76) Inventor: Teresa R. Hickok, Bonita, CA (US)

Correspondence Address: FISH & RICHARDSON, PC, P.O. BOX 1022, MINNEAPOLIS, MN, 55440-1022, US

(21) Appl. No.: 11/521,080

(22) Filed: Sep. 13, 2006

Related U.S. Application Data
(60) Provisional application No. 60/718,626, filed on Sep. 19, 2005.

(51) Int. Cl. A61C 3/03

(52) U.S. Cl. 433/119

(57) ABSTRACT

Disclosed are systems and methods for removing obstructions from the root of a tooth. The system can include a removal instrument having an elongate tubular member having a beveled distal end and a window that communicates with an internal lumen. The window is located proximal to a beveled distal opening in the elongate tubular member. A plunger comprising an elongate shaft is sized to be received by the lumen of the removal instrument.

### REFERENCE TO PRIORITY DOCUMENTS

This application claims priority of co-pending U.S. Provisional Patent Application Ser. No. 60/718,626 entitled “Root Canal Obstruction Removal System”, filed Sep. 19, 2005. Priority of the filing date of Sep. 19, 2005 is hereby claimed, and the disclosure of the Provisional Patent Application is hereby incorporated by reference.

### BACKGROUND

Disclosed are systems and methods for removing an obstruction, such as a broken instrument, from the root canal of a tooth. It should be appreciated that the systems, methods, and mechanisms described herein can be adapted for use in other dental operations.

The human tooth contains a clinical crown and root. The crown portion has a thin outer layer of enamel which covers the underlying tubular dentine. The root's outer layer is comprised of a thin layer of cementum which covers the radicular dentine. Harbored deep and generally running central within these hard tissue structures is the soft tissue called the dental pulp which provides the vascular support and neural supply for the human tooth.

Throughout life, the dental pulp is vulnerable to injuries from decay, trauma, extensive dental procedures, or in certain instances, periodontal disease. These injuries singularly, or in combination, predispose the dental pulp to a cascade of pathological conditions beginning with inflammation and concluding with necrosis.

When these events transpire, patients may present in a dental office with clinical symptoms which, often times, demonstrate abnormalities of the soft tissue, supporting structures, and/or exhibit radiographic evidence of bone loss. The treatment options include palliative emergency care, endodontics (i.e., root canal treatment), or extraction. In other instances patients present with signs and/or symptoms associated with a failing endodonitically treated tooth that requires retreatment or extraction.

To avoid extraction of the tooth, root canal treatment or retreatment is performed. The root canal treatment is directed towards the elimination of pulp, bacteria, and irritants from the root canal system, followed by filling the canal space with an inert, biocompatible, dimensionally stable, root canal filling material. The clinical chain of treatment events are typically anesthesia and isolation procedures followed by cleaning and shaping procedures ideally culminating in three-dimensional obturation of the complex root canal space.

Canal preparation is accomplished utilizing instruments commonly referred to as “files”. Manufacturers provide the doctor with a great variety of file choices ranging from different metals to flute configurations and geometries, tapers, lengths, and handle designs. Additionally, files can be used by hand or rotary instrumentation techniques. During cleaning and shaping procedures, the potential for file breakage is always present. File breakage is further impacted by the quality of manufacturing of the instrument used, the metallurgical properties of the metal from which the instrument is made, the number of times an instrument has previously been used, the degree of calcification, curvature, and length of a particular root canal system, patient cooperation, and importantly, method of use.

Historically retrieving broken instruments or other intercanal obstructions, such as gates glidden drills, lentulo spirals, silver points, and obturation carriers, posed formidable challenges. A broken instrument clearly compromises the prognosis of a case. The instrument can break at any point in the canal. If the coronal end of the broken instrument is near the crown of the tooth, the instrument can be removed fairly easily using traditional or conventional techniques. However, if the instrument breaks deep within the root canal, for example, where the canal begins to bend or curve, extraction of the instrument becomes much more difficult. Currently available retrieval instruments used to retrieve broken instruments cannot reach deep into the root canal, and thus cannot be used when the broken instrument is deep within the root canal. Because the practitioner was still in the process of cleaning and shaping the root canal, there can be bacteria, pulp, endotoxins, etc. deeper in the root canal that still needs to be removed. Thus, breakage of the instrument deep within the root canal can severely impact the outcome of the endodontic procedure.

Typically, the patient is faced with two options when the instrument breaks deep within the root canal. One option is extraction of the tooth. The other option is apical surgery to seal off the end of the root to prevent the bacteria, pulp, edotoxins, etc. from leaking out the end of the root canal.

Over time various retrieval techniques evolved that were crude, often times ineffective, and limited by restricted space. Frequently, efforts directed towards instrument retrieval, even when successful, weakened roots due to overzealous canal enlargement, which in turn predisposed the tooth to subsequent root fractures and, ultimately, the loss of a tooth. Additionally, attempting to remove a broken instrument can lead to serious iatrogenic events, such as perforation of the root or the creation of ledges within the root canal, which can alter prognosis. If retrieval efforts are unsuccessful, cleaning and shaping procedures and obturation are compromised and the ultimate prognosis in placed in doubt.

Lighting and magnification equals vision and are critically essential for safe and successful instrument removal. The introduction of the dental operating microscope has certainly allowed clinicians good looks at the problems. Traditionally, small files were used in efforts to either bypass or eliminate the broken instrument. Varying diameter tubes have been advocated and are placed over the most coronal end of the obstruction and are utilized in a variety of ways to retrieve obstructions. Tubes are attached to the obstruction by glue, mechanical friction, or internal threads which engage certain broken instruments. The most recent advancement in broken instrument removal utilizes ultrasonic systems. Specific ultrasonic instruments have evolved and play a central role in removing broken instruments. Even with all the innovations directed towards safe and successful instrument retrieval a small but statistically significant number of broken instruments can not be retrieved with existing technologies and techniques.

### SUMMARY

Disclosed are systems and methods for removing obstructions, such as broken instruments and other intercarnal obstructions, from the root of a tooth. In one aspect, there is disclosed an obstruction removal system comprising: a microtube abrading instrument having a proximal end configured to be connected to an ultrasonic generator and a distal working end having a lumen for receiving an obstruction; a removal instrument comprising an elongate tubular member having a proximal end with a handle, a beveled distal end and a lumen extending therebetween, wherein the distal end comprises a window that communicates with the lumen, the window located proximal to a beveled distal opening in the elongate tubular member; and a plunger comprising an elongate shaft that is sized to be received by the lumen of the removal instrument, the elongate shaft having a distal end and a proximal end that comprises a handle that engages the handle of the removal instrument

In another aspect, there is disclosed a method of removing a dental obstruction from the mouth of a patient comprising: providing a microtube abrading instrument having a distal working end with a distal lumen for receiving an obstruction, the distal working end further comprising a cutting, filing or rasping surface; connecting the abrading instrument to an ultrasonic generator; inserting the abrading instrument into the mouth of the patient; guiding the distal lumen over the obstruction such that the obstruction is within the distal lumen of the microtube abrading instrument; activating the ultransonic generator to vibrate the distal working end, thereby removing tooth structure around the obstruction; removing the microtube abrading instrument from the mouth of the patient; inserting a removal instrument comprising an elongate tubular member having a proximal end with a handle, a beveled distal end and a lumen extending therebetween, wherein the distal end comprises a window that communicates with the lumen, the window located proximal to a beveled distal opening in the elongate tubular member; advancing the beveled distal end of the removal instrument over the obstruction so that the obstruction is inserted through the beveled distal opening, into the lumen and out the window of the removal instrument; inserting a plunger into the lumen of the removal instrument and advancing the plunger toward the beveled distal opening of the removal instrument until it comes into contact with the obstruction; rotating the plunger until it engages the obstruction; and removing the instrument and plunger from the mouth while maintaining engagement with the obstruction, thereby removing the obstruction from the patient's mouth.

In another aspect, there is disclosed a kit for removing a dental obstruction from the mouth of a patient comprising the following components packaged together: one or more microtube abrading instruments of varying diameters having a proximal end configured to be connected to an ultrasonic generator and a distal working end having a lumen for receiving an obstruction; one or more removal instruments of varying diameters comprising an elongate tubular member having a proximal end with a handle, a beveled distal end and a lumen extending therebetween, wherein the distal end comprises a window that communicates with the lumen, the window located proximal to a beveled distal opening in the elongate tubular member; and one or more plungers of varying diameters corresponding to the one or more removal instruments by size, the one or more plungers comprising an elongate shaft that is sized to be received by the lumen of the removal instrument, the elongate shaft having a distal end and a proximal end that comprises a handle that engages the handle of the removal instrument.

The details of one or more embodiments are set forth in the accompanying drawings and the description below. Other features, objects, and advantages will be apparent from the description and drawings, and from the claims.

### DESCRIPTION OF DRAWINGS

FIG. 1 shows a side view of a microtube instrument that is configured to be connected to an ultrasonic generator

FIG. 2A shows a perspective view of a tube portion of a removal instrument.

FIG. 2B shows a side view of the tube portion of the removal instrument.

FIG. 3A shows a perspective view of a handle that attaches to a proximal end of the tube.

FIG. 3B shows a cross-sectional view of the handle.

FIG. 3C shows an enlarged view of a portion of the handle.

FIG. 4A shows a perspective view of a plunger portion of the removal instrument.

FIG. 4B shows a side view of the plunger.

FIG. 4C shows an enlarged view of a tapered end of the plunger.

### DETAILED DESCRIPTION

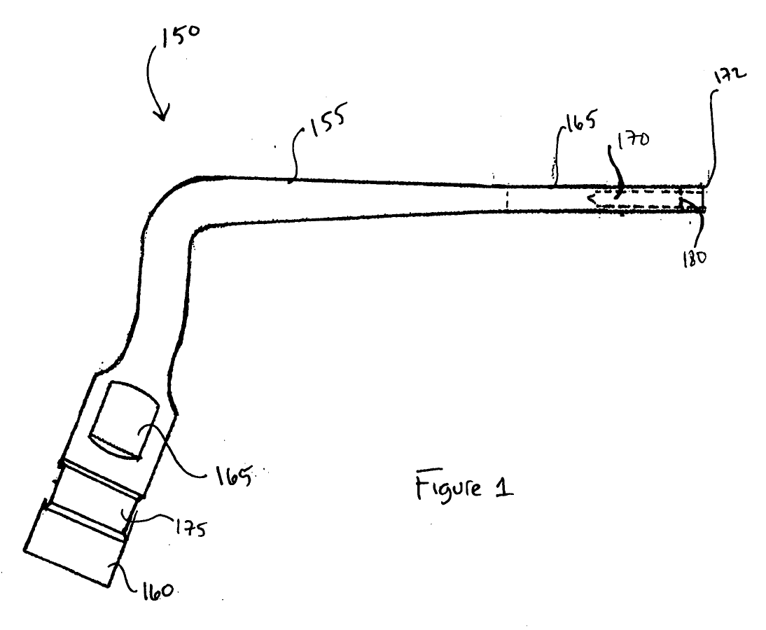

FIG. 1 shows a side view of a microtube instrument 150 that is configured to be connected to an ultrasonic generator, such as an ultrasonic vibrator or transducer of generally well-known conventional construction. The operation and construction of ultrasonic generators are well known to those of ordinary skill in the art and are not described in detail herein.

The microtube instrument 150 includes an elongate shank 155 having a connector 160 at a proximal end of the shank 155. The connector 160 is configured for attachment to a device, such as an ultrasonic generator. The connector 160 can include at least one flat outer surface 165 that provides a place for engagement by a wrench or the like, such as for threadably tightening and loosening the microtube instrument 150 from the ultrasonic generator. The connector 160 can be separable from the microtube instrument, or may be permanently attached. The connector 160 can include a slot 175 for receipt of an indicia, such as a color coded band or ring, for identifying the microtube instrument 150.

In the illustrated embodiment, the shank 155 is bent at an angle beyond the connector 160. Although any type of angle may be used, in one embodiment the shank 155 is bent into a contra-angle. A contra-angle comprises two separate angles as the shank 155 is first curved or bent in a first direction away from the original axis of the shank 155, and is then bent back across the same axis. The shank 155 can also be straight.

The distal region of the shank 155, such as in the region of the working portion 195, can include one or more indicia, such as score marks 180. A clinician can use the score marks 180 to gauge the depth of the microtube instrument 150 into the tooth.

With reference still to FIG. 1, a working portion 165 of the microtube instrument 150 is disposed at the distal end of the shank 155. The working portion 165 includes various structures that provide working ability for the microtube instrument 150. A lumen 170 is contained within the working portion 165 such that the working portion 165 is a generally hollow structure. The lumen 170 generally extends through the working portion 165 a predetermined distance. The lumen 170 can be of generally cylindrical shape such that the outer wall of the working portion has a generally fixed thickness without any openings therethrough. In another embodiment, however, the lumen 170 may be of a non-regular shape leading to the outer wall having a varying thickness along the length of the lumen 170.

In one embodiment, the working portion 165 has an outer wall that gradually reduces in diameter moving in the proximal direction from the distal end of the working portion. Thus, the distal end of the working portion 165 has the largest diameter such that the diameter of the working portion 165 gradually shrinks over the length of the working portion 165 moving in the proximal direction. In another embodiment, the working portion 165 has an outer wall that gradually enlarges in diameter moving in the proximal direction from the distal end of the working portion. Thus, the distal end of the working portion has the smallest diameter such that the diameter of the working portion 165 gradually increases over the length of the working portion 165 moving in the proximal direction.

A cutting, filing or rasping surface 172 is disposed on the distal end of the working portion 165 adjacent the entrance to the lumen 170. The cutting surface 172 is designed to remove tooth structure. The cutting surface 172 may be any type of cutting surface, comprised of any material known to those of ordinary skill in the art. This includes but is not limited to, smooth (knife) edge cutting surfaces, serrated cutting surfaces, saw-toothed cutting surfaces, abrasive surfaces, or any other surface or combination of surfaces. Further, the cutting surface 172 may continue onto the outer surface of the working portion 165 any distance along the working portion 165 as desired and may be constructed as an integral portion of the working portion 172 or may be added on the surface thereof as a coating. In one embodiment, a diamond coating is disposed on the cutting surface 172.

The depth of the lumen 170 into the working portion 165 can vary depending on the length of the working portion, the desired cutting depth available to the microtube instrument 150, and/or the intended use of the microtube instrument 150. In an exemplary embodiment, the distance is about 5 to about 30 millimeters, but that is by no means required and a wide variety of different depths can be used. In another embodiment, the lumen 170 extends further into the shank 155 or through the entire structure of the microtube instrument 150. The diameter and/or cross-sectional shape of the lumen 170 can also depend on similar factors.

As the lumen 170 will generally be placed over the broken end of a broken instrument during use, the cross-sectional area of the lumen may vary widely to allow a wide selection of devices to fit within the lumen 117. In one embodiment, the cross-sectional diameter of a generally cylindrical lumen is about 0.1 to about 2.0 millimeters, but that is by no means required, and a wide variety of different diameters may be used.

The microtube instrument 150 can have a size and shape that compliments a corresponding removal instrument, as described below. In one embodiment the thickness of the wall of the working portion 172 surrounding the lumen 170 is approximately 0.003 inch to approximately 0.008 inch.

The microtube instrument 150 is used to cut around an existing elongate structure, without cutting into the elongate structure, so long as the elongate structure has a cross-sectional area equal to or less than the cross-sectional area of the lumen 170. Most broken instruments will generally have an elongate structure. Therefore the microtube instrument 150 can be used to bore around a broken instrument by placing the broken instrument in the lumen 170. Further, if the cross-sectional area of the lumen 170 and the broken instrument are relatively similar, the microtube instrument 150 will bore quite close to the broken instrument exposing at least a portion of its structure. Finally, because the microtube instrument 150 bores a circle about the broken instrument, the space which needs to be bored out around the broken instrument is generally less than it would be if another cutting instrument was used to bore out around the outside of the broken instrument. In particular, the microtube instrument 150 bores a hole of a diameter equal to the microtube working portion 170.

When used to form a space around a broken instrument trapped in a root canal, the microtube instrument 150 leaves a gap of approximately 0.0005 to 0.010 inches around the broken instrument, as opposed to a gap of about 0.025 inches for conventional ultrasonic instruments. The smaller gap size of the ultrasonic instrument 150 leaves a significant amount of dentin intact, which in turn does not weaken the dentinal wall.

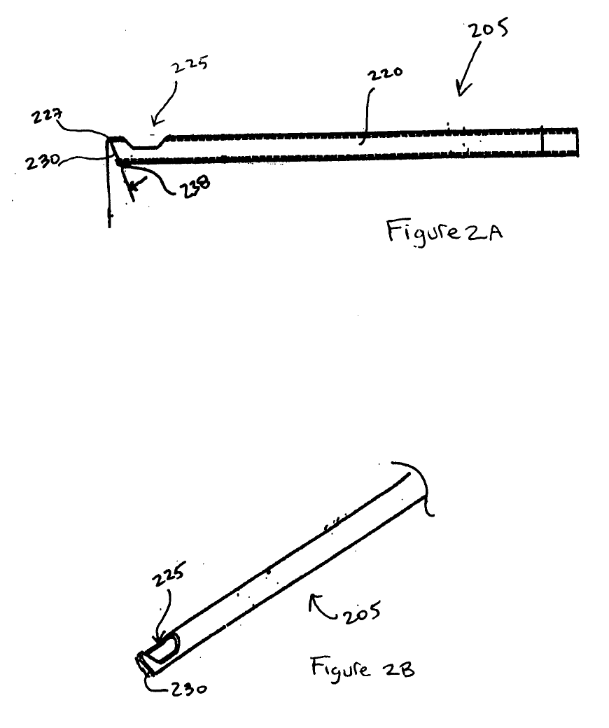

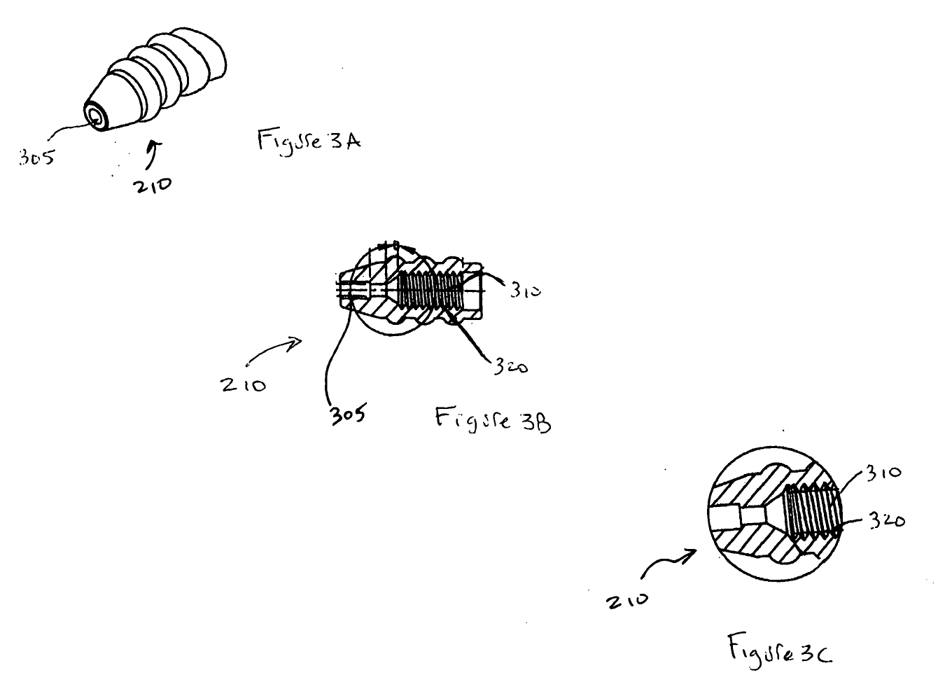

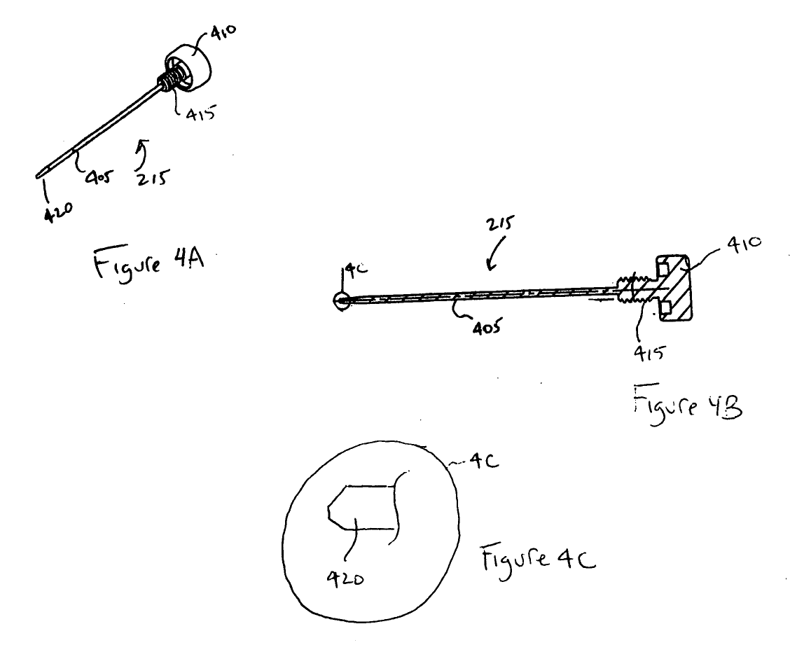

After the ultrasonic instrument 150 is used to form a space around the broken instrument, a removal instrument is engaged with the broken instrument and used to pull the broken instrument out of the tooth. FIGS. 24 show the components of such a removal instrument, which includes a tube 205 (FIGS. 2A and 2B) that is attached to a handle 210 (FIGS. 3A-3C). The removal instrument further includes a plunger 215 (FIG. 4) that is removably positioned inside a lumen of the tube 205, as described below.

With reference to FIGS. 2A and 2B, the tube 205 is an elongate member having an internal lumen 220. A window 225 is disposed at or near a distal end of the tube 205. The window 225 communicates with the internal lumen 220.

A bevel 230 is located at the distal end of the tube 205. The bevel 230 provides the distal end of the tube 205 with a slanted surface relative to the longitudinal axis of the tube 205. As best shown in the side view of FIG. 2B, the bevel 230 is oriented such that a distal-most edge 227 of the bevel 230 is on the same side of the tube 205 as the window 225. The bevel 230 has a proximal edge 238 that is on the opposite side of the tube from the window 225. In other words, the bevel 230 is oriented such that the side of the tube 205 opposite the window 225 is shorter than the side of the tube 205 on which the window 225 is located. The bevel 230 forms an angle A. The value of the angle A can vary, although the angle A can be in the range of about 10 degrees to about 30 degrees, for example.

FIG. 3A shows a perspective view of a handle 210 that attaches to a proximal end of the tube 205. FIG. 3B shows a cross-sectional view of the handle. FIG. 3C shows an enlarged view of a portion of the handle 210. The handle 210 has an enlarged size relative to the diameter of the tube 205 to facilitate grasping of the handle 210 during use. The handle 210 can be manufactured of various materials. In one embodiment, the handle 210 is manufactured of a relatively soft material, such as silicone, for gripping comfort. The handle 210 can be color-coded for identification purposes.

With reference to FIG. 3, the handle 210 has an internal opening 305 for receipt of the proximal end of the tube 205. When the removal device is in an assembled state, the proximal end of the tube 205 is positioned within the opening 305 and secured to the handle 210, such as by using adhesive. The proximal end of the tube 205 can be sandblasted to encourage a strong securement between the handle 210 and the tube 205.

The handle 210 also includes a seat 310 that is sized and shaped to receive a portion of the plunger 215, as described below. The seat 310 forms an opening in the distal end of the handle such that a passageway is formed through the entire handle 210 for receipt of the plunger 215 therethrough. The seat 310 has internal walls with threads 320. The threads 320 are configured to mate with corresponding external threads on the plunger 215, as described below. The threads 320 can be configured to be tightened in response to counter-clockwise rotation of a complimentary-threaded instrument, such as the plunger 215. Thus, when the plunger 215 is inserted into the handle 210, the plunger 215 is tightened into the handle 210 by rotating the plunger 215 in a counter-clockwise direction (as opposed to rotating in a clockwise direction.)

FIG. 4A shows a perspective view of the plunger 215, which includes an elongate rod 405 having a handle 410 at a distal end. FIG. 4B shows a side view of the plunger. FIG. 4C shows an enlarged view of a tapered end of the plunger contained within circle 4C of FIG. 4B. The handle 415 includes external threads 415 that are configured to mate with the internal threads 320 (FIGS. 3B, 3C) of the handle 210 of the tube 205. The elongate rod 405 can be manufactured of various materials, including, for example, 13-8 MO stainless steel, 6AI-4V titanium, or other materials.

The elongate rod 405 is sized to fit within the lumen 220 of the tube 205. In one embodiment, the elongate rod 405 has a diameter that is greater than ⅔ the diameter of the lumen 220. In an exemplary embodiment, the elongate rod 405 has a diameter that leaves no more than about 0.001 inch to about 0.0025 inch space between the outer wall of the plunger rod 405 and the lumen 220 when the rod is concentrically centered in the lumen 220.

The elongate rod 405 has a tapered end 420. The taper is relatively short in length as opposed to a long, gradual taper. The short taper provides the end of the rod 405 with a “stout” shape as opposed to a longer, pointed shape. In one embodiment, the taper extends over a length of about 0.010 inch to about 0.030 inch. In one embodiment, the elongate rod 405 has a length such that the rod does not extend more than about 0.000 inch to about 0.010 inch past the distal end of the tube 205 when the plunger 215 is positioned within the tube.

The instruments described herein can be used to remove a broken instrument (usually an elongate structure) from a tooth, such as from a root canal. Access to a proximal end of the broken instrument is the first step in the removal of a broken instrument. High-speed, friction grip, surgical length burs are selected to create straight-line access to all canal orifices. Radicular access is the second step in removal of a broken instrument. If radicular access is limited, hand files are usually used serially small to large, coronal to the broken instrument, to create sufficient space to safely introduce GG drills. These drills are then used like “brushes” to create additional space and maximize visibility above the broken instrument. Increasingly larger GG's are uniformly stepped out of the canal to create a smooth flowing funnel which is largest at the orifice and narrowest at the proximal end of the broken instrument.

Once a suitable work area has been established, the clinician utilizes an embodiment of a microtube instrument 150 to circumferentially expose a short section of the broken instrument (generally about 2-3 mm). Generally, a clinician will be supplied with a kit of microtube instruments 150 having a variety of instruments scaled for the size of the working area, the tooth, and the broken instrument to be removed. The microtube instruments in this kit will generally have a working portion 195 ranging between 5-30 mm in length, and the lumens 170 will generally have internal diameters that can fit over a variety of different intracanal obstructions ranging from approximately 0.10 mm to 2.00 mm in diameter. Further, microtube instruments and removal instruments in the kit may be made from a variety of different materials including, but not limited to, stainless steel, nickel titanium, titanium, or plastics for different applications.

The appropriate microtube instrument 150 for the particular situation is selected having a size and shape sufficient to reach the broken instrument and pass the proximal end of the broken instrument into the lumen 170, generally without significant excess space. The microtube instrument 150 is inserted into the canal and the proximal end of the broken instrument is directed within the lumen 170. Once the proximal end is within the lumen 170, the microtube instrument 170 may be activated by the clinician. The microtube instrument 170 then bores the area surrounding the broken instrument, generally on all sides. Often, the vibration from the microtube instrument 150 loosens and/or dislodges the broken instrument.

The broken instrument also serves as a guide during the boring procedure. As the broken instrument is within the lumen 170 the microtube instrument 150 will generally remain aligned over the broken instrument following its shape to direct the microtube instrument to carve out the area surrounding the broken instrument, even when the portion of the broken instrument being bored out is not visible. Further, because of the flexibility available to a microtube instrument 150, the microtube instrument 150 can even track broken instruments that are bent or curved in their positioning, allowing for broken instruments much deeper in the canal, or in much more difficult positions, to be removed.

Once a portion of the broken instrument has been exposed, the removal instrument is used to grasp the broken instrument. The clinician visually inspects the broken instrument and selects removal instrument with a tube 205 that is appropriately sized to fit over the broken instrument. In one embodiment, the obstruction has a transverse dimension that is about 20% to about 50% smaller than the lumen 225 in the tube 205.

After selecting the removal instrument for use, the clinician grasps the handle 210 and manipulates the tube 205 down into the tooth such that the tube 205 slides over the broken instrument. Thus, at least a proximal region of the broken instrument is positioned within the lumen 220 of the tube 205. The obstruction is desirably about 20 percent to 50 percent smaller than the lumen that is placed around the obstruction. Such a size differential permits the tube 205 to be tilted back approximately 10 degrees to 20 degrees to permit the broken obstruction to protrude out through the window 225 in the tube 205. If the broken instrument is too large relative to the lumen 220 in the tube, then the tube 205 cannot be tilted.

Moreover, if the broken instrument is less than 50 percent of the lumen size, then further breakage can occur during attempted withdrawal of the broken instrument. The size of the plunger 215 is maximized to provide a maximum bite or purchase between the plunger 215 and the broken instrument. A clinician can visually examine the broken instrument and select a removal instrument that is correctly sized for the size of the broken instrument.

The bevel 230 on the distal end of the tube 205 provides space that permits the tube 205 to be tilted back (in a direction opposite the location of the window 225) against the bevel, which causes a proximal tip of the broken instrument to protrude through the window 225. The plunger 215 is then inserted into the tube 205 so that the threads on the plunger engage the threads on the tube. The plunger 215 is gradually tightened downward such that the distal end of the elongate rod 220 eventually contacts and engages the broken instrument. That is, the plunger 215 presses in between the broken instrument and the internal wall of the tube 205 to grab or purchase onto a portion of the broken instrument. As mentioned, the threaded portion 415 of the plunger 215 tightens in a counter-clockwise rotation into the handle 210 of the tube 205. The broken instrument can be, for example, an endontic file. Such files typically have blades that are arranged in a clockwise spiral configuration similar to a thread that tightens in a clockwise rotation.

Thus, counter-clockwise rotation of the plunger will drive the plunger 215 deeper into the tube 205 and promote engagement between the plunger 215 and the broken instrument. However, the counter-clockwise rotation will not drive the broken file deeper into the canal. To the contrary, the counter-clockwise rotation is more likely to loosen the file from the canal.

Once the plunger 215 has achieved a purchase with the broken instrument, the clinician manipulates the removal instrument by gently rotating the instrument. The rotation is preferably in a counter-clockwise direction. As mentioned, such counter-clockwise rotation can cause the plunger threads 415 to tighten further into the tube 205. Moreover, because the broken instrument tightens in a clockwise rotation, the counterclockwise rotation will not further drive the instrument into the root canal. Indeed, the counterclockwise rotation is more likely to loosen the broken instrument from the root canal.

One effective method of removal is to gently turn the removal instrument, let go of the removal instrument, and then repeat the process again. The removal instrument can be gently wiggled during this process to assist in loosening of the broken instrument from the root canal. The process is repeated until the broken instrument is freed from the root canal. The broken instrument can be unscrewed from the root canal by rotating the broken instrument in a counter-clockwise direction.

Although embodiments of various methods and devices are described herein in detail with reference to certain versions, it should be appreciated that other versions, embodiments, methods of use, and combinations thereof are also possible. Therefore the spirit and scope of the snowboard binding should not be limited to the description of the embodiments contained herein.

What is claimed is:

1. An obstruction removal system comprising:
a microtube abrading instrument having a proximal end configured to be connected to an ultrasonic generator and a distal working end having a lumen for receiving an obstruction;
a removal instrument comprising an elongate tubular member having a proximal end with a handle, a beveled distal end and a lumen extending therebetween, wherein the distal end comprises a window that communicates with the lumen, the window located proximal to a beveled distal opening in the elongate tubular member; and
a plunger comprising an elongate shaft that is sized to be received by the lumen of the removal instrument, the elongate shaft having a distal end and a proximal end that comprises a handle that engages the handle of the removal instrument.

2. The obstruction removal system of claim 1, wherein the handle of the removal instrument comprises internal threads and the handle of the plunger comprises external threads, and wherein the internal threads of the removal instrument mate with the external threads of the plunger.

3. The obstruction removal system of claim 1, wherein the beveled distal end of the elongate tubular member of the removal instrument comprises a slanted surface relative to a longitudinal axis of the elongate tubular member, such that a distal-most edge of the beveled distal end is on a same side of the elongate tubular member as the window and the proximal-most edge of the beveled distal end is on an opposite side of the elongate tubular member from the window.

4. The obstruction removal system of claim 3, wherein the beveled distal end forms a slanted surface having an angle of between about 10 degrees and about 30 degrees.

5. The obstruction removal system of claim 1, wherein the shaft of the plunger has a length relative to the removal instrument such that the distal end of the plunger reaches at least the window of the removal instrument when the handle of the plunger and handle of the removal instrument are engaged with one another.

6. A method of removing a dental obstruction from the mouth of a patient comprising:
providing a microtube abrading instrument having a distal working end with a distal lumen for receiving an obstruction, the distal working end further comprising a cutting, filing or rasping surface;
connecting the abrading instrument to an ultrasonic generator;
inserting the abrading instrument into the mouth of the patient;
guiding the distal lumen over the obstruction such that the obstruction is within the distal lumen of the microtube abrading instrument;
activating the ultransonic generator to vibrate the distal working end, thereby removing tooth structure around the obstruction;
removing the microtube abrading instrument from the mouth of the patient;
inserting a removal instrument comprising an elongate tubular member having a proximal end with a handle, a beveled distal end and a lumen extending therebetween, wherein the distal end comprises a window that communicates with the lumen, the window located proximal to a beveled distal opening in the elongate tubular member;
advancing the beveled distal end of the removal instrument over the obstruction so that the obstruction is inserted through the beveled distal opening, into the lumen and out the window of the removal instrument;
inserting a plunger into the lumen of the removal instrument and advancing the plunger toward the beveled distal opening of the removal instrument until it comes into contact with the obstruction;
rotating the plunger until it engages the obstruction; and
removing the removal instrument and plunger from the mouth while maintaining engagement with the obstruction, thereby removing the obstruction from the patient's mouth.

7. The method of claim 6, wherein the handle of the removal instrument comprises internal threads and the plunger comprises a proximal end having a handle with external threads, and wherein the plunger is advanced toward the beveled distal opening of the removal instrument by rotating the handle of the plunger counter-clockwise into engagement with the handle of the removal instrument.

8. The method of claim 6, wherein the removal instrument is tilted in a direction opposite the location of the window such that the obstruction is guided through the beveled distal opening, through the lumen and out the window of the removal instrument.

9. A kit for removing a dental obstruction from the mouth of a patient comprising the following components packaged together:
one or more microtube abrading instruments of varying diameters having a proximal end configured to be connected to an ultrasonic generator and a distal working end having a lumen for receiving an obstruction;
one or more removal instruments of varying diameters comprising an elongate tubular member having a proximal end with a handle, a beveled distal end and a lumen extending therebetween, wherein the distal end comprises a window that communicates with the lumen, the window located proximal to a beveled distal opening in the elongate tubular member; and
one or more plungers of varying diameters corresponding to the one or more removal instruments by size, the one or more plungers comprising an elongate shaft that is sized to be received by the lumen of the removal instrument, the elongate shaft having a distal end and a proximal end that comprises a handle that engages the handle of the removal instrument.
